(19) United States
(12) Patent Application Publication
(10) Pub. No.: US 2024/0414673 A1
(43) Pub. Date: Dec. 12, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/808,097

(22) Filed: Aug. 19, 2024

Related U.S. Application Data
(63) Continuation of application No. PCT/CN2023/075558, filed on Feb. 12, 2023.

(30) Foreign Application Priority Data
Feb. 22, 2022 (CN) 202210159604.5

(51) Int. Cl. H04W 56/00; H04L 5/00; H04W 74/00; H04W 74/0833

(52) U.S. Cl. CPC H04W 56/0045; H04L 5/0051; H04W 74/002; H04W 74/0833

(57) ABSTRACT

The communication node receives a first information block, the first information block being used to determine a first resource block; and transmits a first signaling in the first resource block, the first signaling being used to indicate a first index; the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised. This application proposes an uplink timing recovery scheme based on reporting for the problem that the UE cannot recover the uplink timing in time, which triggers uplink timing recovery in a timely manner via UE reporting of the non-synchronisation in uplink timing.

### CROSS REFERENCE TO RELATED APPLICATIONS

This application is the continuation of the international patent application No. PCT/CN2023/075558, filed on Feb. 12, 2023, and claims the priority benefit of Chinese Patent Application No. 202210159604.5, filed on Feb. 22, 2022, the full disclosure of which is incorporated herein by reference.

### BACKGROUND

### Technical Field

The present application relates to transmission methods and devices in wireless communication systems, and in particular to a method and device for Multiple Input Multiple Output (MIMO) transmission in a wireless communication system.

### Related Art

MIMO is a key technique of the New Radio (NR) system, which has been successfully commercialized. In Release (Rel)-15/16/17, the 3rd Generation Partner Project (3GPP) has worked on the standardization of Frequency Division Duplex (FDD) and Time Division Duplex (TDD) systems after studying the properties of MIMO, where the focus of studies is for Downlink (DL) MIMO operations. Targeting the Uplink (UL) MIMO, which is considered as a key direction of studies of 3GPP in Rel-18, the 3GPP RAN94e conference has decided on the conduction of the study item of “MIMO Evolution for Downlink and Uplink”, where a further study is required for the provision of additional uplink multiple Transmit/Receive Point (multi-TRP) deployment with enhanced uplink performance by providing two Timing Advances (TAs) and enhanced uplink power control.

### SUMMARY

In the existing system, when the base station detects that the uplink of the User Equipment (UE) is non-synchronised, it sends a Physical Downlink Control Channel (PDCCH) order to the UE, which triggers a random access procedure to enable the UE to resume the uplink timing. The random access procedure based on the PDCCH order can be Contention Free Random Access (CFRA). The UE determines whether the uplink is synchronised or not by maintaining a timeAlignmentTimer. When the timeAlignmentTimer expires, if the base station does not send the PDCCH order, for the Special Cell (SpCell), it needs to perform Contention Based Random Access (CBRA) to restore uplink timing, while for the Secondary Cell (SCell), the UE cannot perform CBRA and can only wait for the base station to detect the uplink non-synchronisation of the UE before it has a chance to restore uplink timing, therefore, how to restore uplink timing as soon as possible needs to be enhanced. In particular, the existing system supports only one TA in a cell, and when TAs of multiple TRPs in a cell are different and the TA of one of the TRPs is non-synchronised, how to recover the uplink timing as soon as possible needs to be enhanced.

To address the above problem, the present application provides a solution. In the description of the above problem, the uu-interface scenario is used as an example; the present application is equally applicable to, for example, the Sidelink (SL) or Integrated Access and Backhaul (IAB) scenarios, to achieve similar technical effects as in the uu-interface scenario. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
receiving a first information block, the first information block being used to determine a first resource block; and
transmitting a first signaling in the first resource block, the first signaling being used to indicate a first index;
herein, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, a transmitter of the first information block is different from a receiver of the first signaling.

In one embodiment, a transmitter of the first information block is the same as a receiver of the first signaling.

In one embodiment, a transmitter of the first information block and a receiver of the first signaling belong to a same cell.

In one embodiment, a transmitter of the first information block and a receiver of the first signaling belong to different cells.

In one embodiment, a problem to be solved in the present application includes: how to notify the base station of the occurrence of an uplink non-synchronisation in the UE.

In one embodiment, a problem to be solved in the present application includes: how to recover an uplink non-synchronisation in a timely manner.

In one embodiment, a problem to be solved in the present application includes: how to recover an uplink non-synchronisation for a TRP.

In one embodiment, a problem to be solved in the present application includes: how to recover an uplink non-synchronisation for a Timing Advance Group (TAG).

In one embodiment, characteristics of the above method include: indicating to the base station that the uplink is non-synchronised.

In one embodiment, characteristics of the above method include: indicating to the base station a TAG of which the uplink is non-synchronised.

In one embodiment, characteristics of the above method include: indicating to the base station a TRP of which the uplink is non-synchronised.

In one embodiment, characteristics of the above method include: indicating to the base station a cell of which the uplink is non-synchronised.

In one embodiment, an advantage of the above method includes: helping the base station to make a decision based on the first signaling.

In one embodiment, an advantage of the above method includes: helping the base station to trigger a PDCCH order in a timely manner.

In one embodiment, an advantage of the above method includes: facilitating a quick recovery from non-synchronisation.

In one embodiment, an advantage of the above method includes: indicating to the base station when necessary that the uplink is non-synchronised and recovers from the uplink non-synchronisation in a timely manner.

According to one aspect of the present application, characterized in comprising:
determining that a first condition is satisfied, that the first condition is satisfied being used to trigger the first signaling;

herein, the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised.

According to one aspect of the present application, characterized in comprising:
triggering a first out-of-sync report as a response to that the first condition is satisfied; the first out-of-sync report being used to trigger the first signaling.

According to one aspect of the present application, characterized in comprising:
receiving a first DCI, the first DCI (i.e., Downlink Control Information) being used to indicate a first reference signal resource, the first reference signal resource being used for a first random access procedure; the first reference signal resource is associated with the first index; the first DCI is a physical layer signaling.

In one embodiment, a transmitter of the first DCI is different from a receiver of the first signaling.

In one embodiment, a transmitter of the first DCI is the same as a receiver of the first signaling.

In one embodiment, a transmitter of the first DCI and a receiver of the first signaling belong to a same cell.

In one embodiment, a transmitter of the first DCI and a receiver of the first signaling belong to different cells.

According to one aspect of the present application, characterized in comprising:
transmitting a first signal according to the first DCI, the first signal including a random access preamble;
monitoring a second DCI as a response to the first signal being transmitted;
herein, the first signal and the second DCI belong to the first random access procedure; the second DCI is a physical layer signaling.

In one embodiment, a receiver of the first signal is different from a transmitter of the first DCI.

In one embodiment, a receiver of the first signal is the same as a transmitter of the first DCI.

In one embodiment, a receiver of the first signal and a transmitter of the first DCI belong to a same cell.

In one embodiment, a receiver of the first signal and a transmitter of the first DCI belong to different cells.

In one embodiment, a transmitter of the second DCI is different from a transmitter of the first DCI.

In one embodiment, a transmitter of the second DCI is the same as a transmitter of the first DCI.

In one embodiment, a transmitter of the second DCI and a transmitter of the first DCI belong to a same cell.

In one embodiment, a transmitter of the second DCI and a transmitter of the first DCI belong to different cells.

According to one aspect of the present application, characterized in comprising:
monitoring the first DCI as a response to the first signaling being transmitted.

According to one aspect of the present application, characterized in comprising:
starting or restarting the first timer as a response to the second DCI being received, or starting or restarting the first timer as a response to the second signaling being received;
herein, the second DCI is used to indicate a first amount of timing adjustment; or, the second signaling is used to indicate the first amount of timing adjustment.

The present application provides another method in a first node for wireless communications, comprising:
triggering a first out-of-sync report as a response to that the first condition is satisfied;
herein, the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised; that the first out-of-sync report is satisfied is used to trigger a first signaling; the first signaling being used to indicate a first index; the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

According to one aspect of the present application, characterized in comprising:
receiving a first information block, the first information block being used to determine a first resource block; and
transmitting a first signaling in the first resource block.

According to one aspect of the present application, characterized in comprising:
receiving a first DCI, the first DCI being used to indicate a first reference signal resource, the first reference signal resource being used for a first random access procedure; the first reference signal resource is associated with the first index; the first DCI is a physical layer signaling.

According to one aspect of the present application, characterized in comprising:
canceling the first out-of-sync report as a response to the first DCI being received.

According to one aspect of the present application, characterized in comprising:
transmitting a first signal according to the first DCI, the first signal including a random access preamble;
monitoring a second DCI as a response to the first signal being transmitted;
herein, the first signal and the second DCI belong to the first random access procedure; the second DCI is a physical layer signaling.

According to one aspect of the present application, characterized in comprising:
receiving a first timing advance command; and as a response to the first timing advance command being received, canceling the first out-of-sync report;
herein, the first timing advance command is used to indicate a timing advance being associated with the reference signal resource corresponding to the first index.

According to one aspect of the present application, characterized in comprising:
canceling the first out-of-sync report as a response to the first signaling being transmitted.

According to one aspect of the present application, characterized in comprising:
starting or restarting the first timer as a response to the second DCI being received, or starting or restarting the first timer as a response to the second signaling being received;
herein, the second DCI is used to indicate a first amount of timing adjustment; or, the second signaling is used to indicate the first amount of timing adjustment.

The present application provides a method in a second node for wireless communications, comprising:
transmitting a first information block, the first information block being used to determine a first resource block; and
receiving a first signaling in the first resource block, the first signaling being used to indicate a first index;
herein, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

According to one aspect of the present application, characterized in that it is determined that a first condition is satisfied, that the first condition is satisfied being used to trigger the first signaling; herein, the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised.

According to one aspect of the present application, characterized in that a first out-of-sync report is triggered as a response to that the first condition is satisfied; the first out-of-sync report being used to trigger the first signaling.

According to one aspect of the present application, characterized in comprising:
transmitting a first DCI, the first DCI being used to indicate a first reference signal resource, the first reference signal resource being used for a first random access procedure; the first reference signal resource is associated with the first index; the first DCI is a physical layer signaling.

According to one aspect of the present application, characterized in comprising:
receiving a first signal, the first signal including a random access preamble; and
transmitting a second DCI as a response to the first signal being received;
herein, the first signal is transmitted according to the first DCI; the first signal and the second DCI belong to the first random access procedure; the second DCI is a physical layer signaling.

According to one aspect of the present application, characterized in that as a response to the first signaling being transmitted, the first DCI is monitored.

According to one aspect of the present application, characterized in that as a response to the second DCI being received, the first timer is started or restarted; or, as a response to the second signaling being received, the first timer is started or restarted; herein, the second DCI is used to indicate a first amount of timing adjustment; or, the second signaling is used to indicate the first amount of timing adjustment.

The present application provides a first node for wireless communications, comprising:
a first receiver, receiving a first information block, the first information block being used to determine a first resource block; and
a first transmitter, transmitting a first signaling in the first resource block, the first signaling being used to indicate a first index;
herein, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

The present application provides a second node for wireless communications, comprising:
a second transmitter, transmitting a first information block, the first information block being used to determine a first resource block; and
a second receiver, receiving a first signaling in the first resource block, the first signaling being used to indicate a first index;
herein, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, compared with the prior art, the present application is advantageous in the following aspects:
it helps the base station with decision making based on the first signaling;
it helps the base station with timely triggering of a PDCCH order;
it is beneficial for quick recovery from non-synchronisation in uplink;
it indicates to the base station when necessary that the uplink is non-synchronised and recovers from the uplink non-synchronisation in a timely manner.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmitting a first information block and a first signaling according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to another embodiment of the present application.

FIG. 7 illustrates a flowchart of a first out-of-sync report according to one embodiment of the present application.

FIG. 8 illustrates a flowchart of radio signal transmission of canceling a first out-of-sync report according to one embodiment of the present application.

FIG. 9 illustrates a flowchart of radio signal transmission of canceling a first out-of-sync report according to another embodiment of the present application.

FIG. 10 illustrates a flowchart of radio signal transmission of canceling a first out-of-sync report according to a third embodiment of the present application.

FIG. 11 illustrates a structure block diagram of a processing device used in a first node according to one embodiment of the present application.

FIG. 12 illustrates a structure block diagram of a processing device used in a second node according to one embodiment of the present application.

FIG. 13 illustrates a schematic diagram of a first signaling comprising a first MAC CE according to one embodiment of the present application.

FIG. 14 illustrates a schematic diagram of a first index comprising a first sub-index and a second sub-index according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

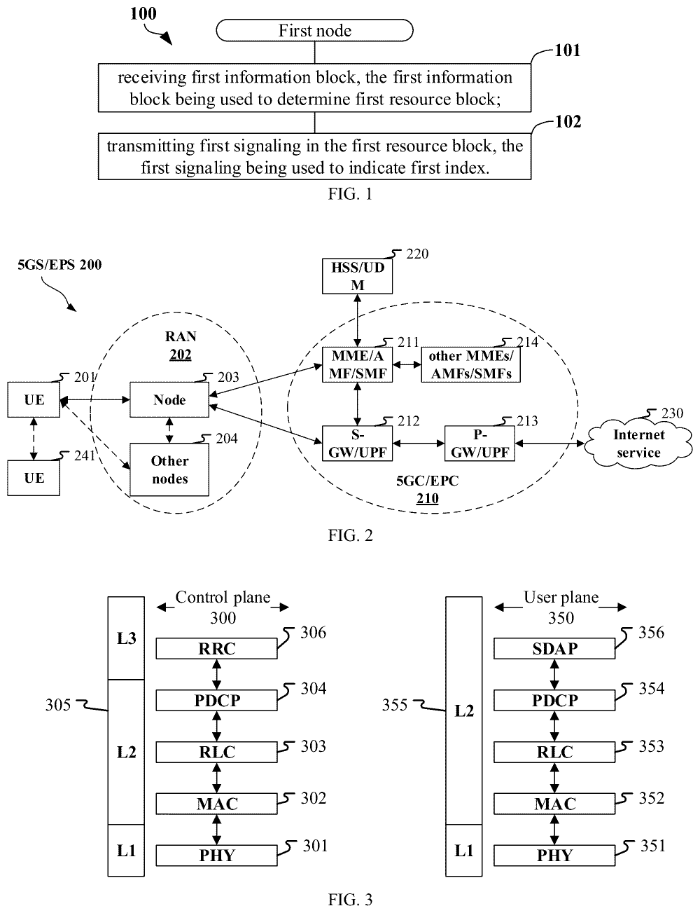

Embodiment 1 illustrates a flowchart of transmitting a first information block and a first signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first information block in step 101, the first information block being used to determine a first resource block; and transmits a first signaling in the first resource block in step 102, the first signaling being used to indicate a first index; herein, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, a transmitter of the first information block is different from a receiver of the first signaling.

In one embodiment, a transmitter of the first information block is the same as a receiver of the first signaling.

In one embodiment, a transmitter of the first information block and a receiver of the first signaling belong to a same cell.

In one embodiment, a transmitter of the first information block and a receiver of the first signaling belong to different cells.

In one embodiment, a receiver of the first signaling is a first TRP.

In one embodiment, a transmitter of the first information block is a first TRP.

In one embodiment, a transmitter of the first information block is a second TRP.

In one embodiment, the first TRP belongs to a first cell, and the second TRP belongs to the first cell.

In one embodiment, the first TRP belongs to a first cell, while the second TRP belongs to a second cell.

In one embodiment, the first cell is a SpCell.

In one embodiment, the first cell is an SCell.

In one embodiment, the first cell is a SpCell, and the second cell is an SCell.

In one embodiment, the first cell and the second cell belong to a Master Cell Group (MCG).

In one embodiment, the first cell and the second cell belong to a Secondary Cell Group (SCG).

In one embodiment, the first cell is a cell configured with a servCellIndex and the second cell is not configured with a servCellIndex; the first node is able to be scheduled with radio resources of the second cell in the first cell.

In one embodiment, the first information block comprises a Radio Resource Control (RRC) Message.

In one embodiment, the first information block comprises at least one RRC Information Element (IE).

In one embodiment, the first information block comprises at least one RRC Field.

In one embodiment, the first information block comprises a RRCReconfiguration message.

In one embodiment, the first information block comprises at least one RRC IE in a RRCReconfiguration message.

In one embodiment, the first information block comprises at least one RRC Field in a RRCReconfiguration message.

In one embodiment, the first information block comprises a ConfiguredGrantConfig IE.

In one embodiment, the first information block comprises a resourceAllocation field.

In one embodiment, the first information block comprises a MsgA-ConfigCommon IE

In one embodiment, the first information block comprises a MsgA-PUSCH-Config IE.

In one embodiment, the first information block comprises a Medium Access Control (MAC) Random Access Response (RAR).

In one embodiment, the first information block comprises at least one MAC Field.

In one embodiment, the first information block comprises a UL Grant Field.

In one embodiment, the first information block is a MAC RAR.

In one embodiment, the first information block comprises a MAC Field, the MAC Field being a UL Grant Field.

In one embodiment, the first information block comprises a DCI.

In one embodiment, the first information block comprises at least one DCI Field.

In one embodiment, the first information block is a DCI.

In one embodiment, the first information block comprises a DCI, the DCI being in a DCI format 0_0.

In one embodiment, the first information block comprises a DCI, the DCI being in a DCI format 0_1.

In one embodiment, the first information block comprises a DCI, the DCI being in a DCI format 0_2.

In one embodiment, the first information block is received via a PDCCH.

In one embodiment, the phrase the first information block being used to determine a first resource block includes that the first information block is used to indicate the first resource block.

In one embodiment, the phrase the first information block being used to determine a first resource block includes that the first information block explicitly indicates the first resource block.

In one embodiment, the phrase the first information block being used to determine a first resource block includes that the first information block implicitly indicates the first resource block.

In one embodiment, the phrase the first information block being used to determine a first resource block includes that the first information block is used to carry the first resource block.

In one embodiment, the phrase the first information block being used to determine a first resource block includes that the first resource block is configured by the first information block.

In one embodiment, the phrase the first information block being used to determine a first resource block includes that the first information block is used to determine a relationship between the first resource block and Message A (MSGA).

In one embodiment, the phrase the first information block being used to determine a first resource block includes that the first information block is used to determine at least one of Time domain resource assignment, or Frequency domain resource assignment, or MCS (i.e., Modulation and Coding Scheme), or Hybrid automatic repeat request (HARQ) process number, or Redundancy version (RV) of the first resource block.

In one embodiment, the first resource block is a physical layer resource.

In one embodiment, the first resource block is an MSGA-associated Physical Uplink Shared Channel (PUSCH) resource.

In one embodiment, the first resource block is a PUSCH resource.

In one embodiment, the first resource block is a UL grant.

In one embodiment, the first resource block is used for PUSCH transmission.

In one embodiment, the first resource block is used for transmission on an Uplink Shared Channel (UL-SCH).

In one embodiment, the first resource block is used for uplink transmission.

In one embodiment, the first signaling is a physical layer signaling.

In one embodiment, the first signaling comprises a piece of Uplink Control Information (UCI).

In one embodiment, the first signaling comprises a UCI, a field of the UCI indicating the first index.

In one embodiment, the first signaling comprises at least one UCI field.

In one embodiment, the first signaling is a MAC layer signaling.

In one embodiment, the first signaling comprises at least one MAC field.

In one embodiment, the first signaling comprises one MAC Protocol Data Unit (PDU).

In one embodiment, the first signaling comprises one MAC subPDU.

In one embodiment, the first signaling comprises a MAC CE, a field of the MAC CE indicating the first index.

In one embodiment, the first signaling comprises a first MAC CE, the first MAC CE comprising at least a first bitmap, any bit in the first bitmap indicating a candidate index, the first index being a candidate index in the first bitmap.

In one subembodiment, the first MAC CE comprises at least one octet.

In one subembodiment, the first MAC CE comprises one octet.

In one subembodiment, the first MAC CE comprises two octets.

In one embodiment, the first signaling comprises a MAC subPDU, the MAC subPDU comprising a MAC CE and a MAC subheader; the MAC CE is used to indicate the first index; the MAC subheader comprises a Logical channel identifier (LCID) field, the LCID field being used to indicate the MAC CE, the LCID field being set to an integer, the integer being no less than 35 and no greater than 44.

In one embodiment, the first signaling comprises a MAC subPDU, the MAC subPDU comprising a MAC CE and a MAC subheader; the MAC CE is used to indicate the first index; the MAC subheader comprises an Extended LCID (eLCID) field, the eLCID field being used to indicate the MAC CE, the eLCID field being set to an integer, the integer being no less than 0 and no greater than 249.

In one embodiment, the first signaling is a PUSCH transmission.

In one embodiment, the first signaling is an RRC layer signaling.

In one embodiment, the first signaling explicitly indicates the first index.

In one embodiment, the first signaling implicitly indicates the first index.

In one embodiment, the first signaling comprises the first index.

In one embodiment, a field of the first signaling indicates the first index.

In one embodiment, a field of the first signaling is set to the first index.

In one embodiment, a field of the first signaling is associated with the first index.

In one embodiment, the first signaling comprises one bitmap, one bit in the one bitmap indicating a candidate index among the multiple candidate indexes.

In one embodiment, if one bit in the one bitmap is set to 1, it's indicated that an uplink transmission associated with a reference signal resource corresponding to a candidate index indicated by the one bit is determined to be non-synchronised; if one bit in the one bitmap is set to 0, it's indicated that an uplink transmission associated with a reference signal resource corresponding to a candidate index indicated by the one bit is not determined to be non-synchronised.

In one embodiment, one bit in the one bitmap indicates the first index and the one bit corresponding to the first index is set to 1.

In one embodiment, the one bitmap comprises N1 bits.

In one embodiment, the one bitmap is a MAC CE.

In one subembodiment, the one bitmap has a length equal to 8 bits.

In one subembodiment, the one bitmap has a length equal to 16 bits.

In one embodiment, the one bitmap is a field in a MAC CE, the MAC CE comprising one R field.

In one subembodiment, the one bitmap has a length equal to 4 bits and the one R field comprises 4 bits.

In one subembodiment, the one bitmap has a length equal to 6 bits and the one R field comprises 2 bits.

In one embodiment, the multiple candidate indexes include N1 candidate indexes, the N1 candidate indexes correspond to N1 resource groups, and one candidate index of the N1 candidate indexes corresponds to one resource group of the N1 resource groups.

In one subembodiment, one candidate index of the N1 candidate indexes indicates one resource group of the N1 resource groups.

In one subembodiment, the N1 candidate indexes respectively correspond to the N1 resource groups.

In one subembodiment, one candidate index of the N1 candidate indexes corresponds to at least one reference signal resource.

In one embodiment, the at least one reference signal resource belongs/belong to a same TAG.

In one embodiment, the at least one reference signal resource belongs/belong to a same cell.

In one embodiment, the at least one reference signal resource belongs/belong to a same TRP.

In one subembodiment, N1 is a positive integer.

In one subembodiment, N1 is a positive integer.

In one subembodiment, each of the N1 resource groups is a TAG and each of the N1 candidate indexes is a TAG ID.

In one subsidiary embodiment of the above subembodiment, N1 is equal to 4, and the N1 candidate indexes are 0, 1, 2, 3, respectively.

In one subsidiary embodiment of the above subembodiment, N1 is equal to 8, and the N1 candidate indexes are 0, 1, 2, 3, 4, 5, 6, 7, respectively.

In one subembodiment, each of the N1 resource groups is associated to a TRP and each of the N1 candidate indexes indicates a resource group.

In one subsidiary embodiment of the above subembodiment, N1 is equal to 4, and the N1 candidate indexes are 0, 1, 2, 3, respectively.

In one subsidiary embodiment of the above subembodiment, N1 is equal to 8, and the N1 candidate indexes are 0, 1, 2, 3, 4, 5, 6, 7, respectively.

In one embodiment, each of the N1 resource groups is a TAG, and the N1 candidate indexes are each a TAG ID.

In one embodiment, each resource group in the first resource set is a cell.

In one embodiment, each resource group in the first resource set is a TRP.

In one embodiment, each resource group in the first resource set is associated to a TRP.

In one embodiment, each resource group in the first resource set comprises at least one Reference Signal (RS) resource.

In one embodiment, each resource group in the first resource set is associated to one RS resource set, the one RS resource set being related to q0.

In one subembodiment, the one RS resource set is q0.

In one subembodiment, the one RS resource set includes q0.

In one subembodiment, any RS resource in the one RS resource set and any RS resource in the q0 belong to the same one TRP.

In one embodiment, the phrase the first index being associated with a first resource group includes that the first index explicitly indicates the first resource group.

In one embodiment, the phrase the first index being associated with a first resource group includes that the first index implicitly indicates the first resource group.

In one embodiment, the phrase the first index being associated with a first resource group includes that the first index is an index of the first resource group.

In one embodiment, the phrase the first index being associated with a first resource group includes that the first index is an index of a TAG to which the first resource group belongs.

In one embodiment, any candidate index of the multiple candidate indexes indicates a TAG, each TAG including at least one cell.

In one embodiment, the multiple candidate indexes include at least 2 candidate indexes.

In one embodiment, the multiple candidate indexes are 2 candidate indexes.

In one embodiment, the multiple candidate indexes are 4 candidate indexes.

In one embodiment, the multiple candidate indexes are indexes of TRPs, the first index indicating a first TRP.

In one embodiment, any candidate index of the multiple candidate indexes indicates a TRP.

In one embodiment, any candidate index of the multiple candidate indexes indicates a TAG.

In one embodiment, the first TRP belongs to a first TAG and the second TRP belongs to the second TAG.

In one embodiment, the first index indicates a first TAG.

In one embodiment, the first TRP belongs to the first TAG.

In one embodiment, any candidate index of the multiple candidate indexes indicates a TRP in a cell.

In one embodiment, any candidate index of the multiple candidate indexes includes a TAG Identity (ID).

In one embodiment, any candidate index of the multiple candidate indexes includes an index of a resource group.

In one embodiment, any candidate index of the multiple candidate indexes includes an index of a Control Resource Set (CORESET).

In one embodiment, any candidate index of the multiple candidate indexes includes an index of a Transmission Configuration Indicator (TCI).

In one embodiment, any candidate index of the multiple candidate indexes includes an index of a group of Control Resource Sets (CORESETs).

In one embodiment, any candidate index of the multiple candidate indexes includes an index of a group of Transmission Configuration Indicators (TCIs).

In one embodiment, any candidate index of the multiple candidate indexes includes an index of a reference signal resource set.

In one embodiment, any candidate index of the multiple candidate indexes includes an index of a cell identity.

In one embodiment, any candidate index of the multiple candidate indexes includes an index of a cell identity and an index of a reference signal resource set.

In one embodiment, any reference signal resource of the at least one reference signal resource corresponding to any candidate index of the multiple candidate indexes comprises a downlink reference signal.

In one embodiment, any reference signal resource of the at least one reference signal resource corresponding to any candidate index of the multiple candidate indexes comprises an uplink reference signal.

In one embodiment, any reference signal resource of the at least one reference signal resource corresponding to any candidate index of the multiple candidate indexes is at least one of a Physical Uplink Control Channel (PUCCH) resource, or a Sounding Reference Signal (SRS) resource, or a PUSCH resource, or a Scheduling Request (SR) resource, or a Synchronisation Signal (SS)/Physical Broadcast Channel (PBCH) resource, or a SS/PBCH Block (SSB) resource, or a Channel State Information Reference Signal (CSI-RS), or a Demodulation Reference Signal (DMRS).

In one embodiment, at least one reference signal resource corresponding to any candidate index of the multiple candidate indexes belongs/belong to a same resource group.

In one embodiment, any reference signal resource of the at least one reference signal resource corresponding to any candidate index of the multiple candidate indexes is configured with the same resource group index.

In one embodiment, at least one reference signal resource corresponding to any candidate index of the multiple candidate indexes belongs/belong to at least one cell.

In one embodiment, at least one reference signal resource corresponding to any candidate index of the multiple candidate indexes belongs/belong to a same cell.

In one embodiment, at least one reference signal resource corresponding to any candidate index of the multiple candidate indexes belongs/belong to a same TRP.

In one embodiment, the phrase that any of the multiple candidate indexes corresponds to at least one reference signal resource includes that any of the multiple candidate indexes corresponds to a TAG, the TAG comprising at least one cell, the one cell being configured with at least one reference signal resource.

In one embodiment, the phrase that any of the multiple candidate indexes corresponds to at least one reference signal resource includes that any of the multiple candidate indexes corresponds to an RS resource group, the RS resource group being configured with at least one reference signal resource.

In one embodiment, the phrase that any of the multiple candidate indexes corresponds to at least one reference signal resource includes that any of the multiple candidate indexes corresponds to a TRP, the TRP being configured with at least one reference signal resource.

In one embodiment, the phrase that an uplink transmission being associated with a reference signal resource corresponding to the first index is non-synchronised includes that an uplink transmission for a cell configured with the first index is non-synchronised.

In one embodiment, the phrase that an uplink transmission being associated with a reference signal resource corresponding to the first index is non-synchronised includes that an uplink transmission for a TRP configured with the first index is non-synchronised.

In one embodiment, the phrase that an uplink transmission being associated with a reference signal resource corresponding to the first index is non-synchronised includes that an uplink transmission for an RS resource group configured with the first index is non-synchronised.

In one embodiment, the phrase that an uplink transmission being associated with a reference signal resource corresponding to the first index is non-synchronised includes that an uplink transmission for a reference signal resource configured with the first index is non-synchronised.

In one embodiment, the phrase that an uplink transmission being associated with a reference signal resource corresponding to the first index is non-synchronised includes that uplink transmissions associated with all reference signal resources corresponding to the first index are non-synchronised.

In one embodiment, the phrase that an uplink transmission being associated with a reference signal resource corresponding to the first index is non-synchronised includes that uplink transmissions for all reference signal resources configured with the first index are non-synchronised.

In one embodiment, the uplink transmission being non-synchronised means: the uplink time being not aligned.

In one embodiment, the uplink transmission being non-synchronised means: the uplink timing being not aligned.

In one embodiment, the uplink transmission being non-synchronised means: the uplink being non-synchronised.

In one embodiment, the uplink transmission being non-synchronised means: the transmission time for the uplink transmission being not aligned.

In one embodiment, the phrase that an uplink transmission being associated with a reference signal resource corresponding to the first index is non-synchronised includes that a MAC entity considers an uplink transmission for a reference signal resource that belongs to a TAG indicated by the first index to be non-synchronised.

In one embodiment, any one of the multiple candidate indexes is a TAG ID, and any of the at least one reference signal resource corresponding to any one of the multiple candidate indexes belongs to a cell, the cell being configured with the TAG ID.

In one embodiment, any one of the multiple candidate indexes is a TAG ID, and any of the at least one reference signal resource corresponding to any one of the multiple candidate indexes belongs to an RS resource group, the RS resource group being configured with the TAG ID.

In one subembodiment, the RS resource group is associated with a TRP.

In one subembodiment, each RS resource in the RS resource group is transmitted by a TRP.

In one subembodiment, each RS resource in the RS resource group belongs to a TRP.

In one embodiment, one of the multiple candidate indexes indicates one TAG, the one TAG corresponding to at least one reference signal resource.

In one subembodiment, the one TAG includes at least one cell, and any one of the at least one cell includes at least one reference signal resource.

In one embodiment, one of the multiple candidate indexes indicates one cell, the one cell corresponding to at least one reference signal resource.

In one embodiment, one of the multiple candidate indexes indicates one TRP, the one TRP corresponding to at least one reference signal resource.

In one embodiment, at least one reference signal resource corresponding to one candidate index of the multiple candidate indexes belongs/belong to a same TRP.

In one embodiment, at least one reference signal resource corresponding to one candidate index of the multiple candidate indexes is/are associated to a same TRP

In one embodiment, at least one reference signal resource corresponding to one candidate index of the multiple candidate indexes is/are quasi co-located.

In one embodiment, at least one reference signal resource corresponding to one candidate index of the multiple candidate indexes have a same Timing Advance (TA).

In one embodiment, at least one reference signal resource corresponding to one candidate index of the multiple candidate indexes have a same amount of Timing Advance (TA).

In one embodiment, at least one reference signal resource corresponding to one candidate index of the multiple candidate indexes are co-located.

In one embodiment, at least one reference signal resource corresponding to one candidate index of the multiple candidate indexes belongs/belong to a reference signal set, all reference signal resources in the reference signal set belonging to a same TRP.

In one embodiment, any candidate index of the multiple candidate indexes corresponds to a TRP.

In one embodiment, reference signal resources respectively corresponding to any two candidate indexes of the multiple candidate indexes belong to a same serving cell.

In one embodiment, reference signal resources respectively corresponding to any two candidate indexes of the multiple candidate indexes belong to different cells.

In one embodiment, reference signal resources respectively corresponding to any two candidate indexes of the multiple candidate indexes belong to two cells, the two cells having different Physical Cell Identifiers (PCIs).

In one embodiment, a reference signal resource corresponding to any one of the multiple candidate indexes belongs to a first cell.

### Embodiment 2

Embodiment 2 illustrates a schematic diagram of a network architecture according to one embodiment of the present application, as shown in FIG. 2. FIG. 2 illustrates a network architecture 200 of 5G New Radio (NR)/Long-Term Evolution (LTE)/Long-Term Evolution Advanced (LTE-A) systems. The 5G NR/LTE/LTE-A network architecture 200 may be called a 5G System/Evolved Packet System (5GS/EPS) 200 or other suitable terminology. The 5GS/EPS 200 may comprise UE(s) 201, a RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The RAN comprises a node 203 and another node 204. The node 203 provides UE 201 oriented user plane and control plane terminations. The node 203 can be connected to the other node 204 via an Xn interface (like backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the node 203 corresponds to the second node in the present application.

In one embodiment, the node 203 comprises at least one BaseStation (BS).

In one embodiment, the node 203 comprises at least one TRP.

In one embodiment, the node 203 comprises a maintenance base station for a cell.

In one embodiment, the node 203 comprises a maintenance base station for multiple cells.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is a ng-eNB.

In one embodiment, the node 203 is an en-gNB.

In one embodiment, the node 203 is a UE.

In one embodiment, the node 203 is a relay.

In one embodiment, the node 203 is a Gateway.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE comprises an aircraft.

In one embodiment, the UE comprises a vehicle-mounted terminal.

In one embodiment, the UE comprises a vessel.

In one embodiment, the UE comprises an Internet-of-Things (IoT) terminal.

In one embodiment, the UE comprises an Industrial IoT (IIoT) terminal.

In one embodiment, the UE comprises a piece of equipment supporting transmissions with low delay and high reliability.

In one embodiment, the UE comprises test equipment.

In one embodiment, the UE comprises a signaling test instrument.

In one embodiment, the base station supports transmissions in NTN.

In one embodiment, the base station supports transmissions in large-delay-difference networks.

In one embodiment, the base station supports transmissions in TN.

In one embodiment, the base station comprises a MacroCellular base station.

In one embodiment, the base station comprises a Micro Cell base station.

In one embodiment, the base station comprises a Pico Cell base station.

In one embodiment, the base station comprises a Femtocell.

In one embodiment, the base station comprises abase station device supporting large time-delay difference.

In one embodiment, the base station comprises a flight platform.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling test instrument.

In one embodiment, the base station comprises an Integrated Access and Backhaul-node (IAB-node).

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises a L3 relay.

In one embodiment, the relay comprises a L2 relay.

In one embodiment, the relay comprises a Router.

In one embodiment, the relay comprises an Exchanger.

In one embodiment, the relay comprises a UE.

In one embodiment, the relay comprises a base station.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are layer1, layer2 and layer3. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the first information block in the present application is generated by the RRC306.

In one embodiment, the first information block in the present application is generated by the MAC302 or the MAC352.

In one embodiment, the first information block in the present application is generated by the PHY301 or the PHY351.

In one embodiment, the first signaling in the present application is generated by the RRC 306.

In one embodiment, the first signaling in the present application is generated by the MAC302 or the MAC352.

In one embodiment, the first signaling in the present application is generated by the PHY301 or the PHY351.

In one embodiment, the first signal in the present application is generated by the RRC306.

In one embodiment, the first signal in the present application is generated by the MAC302 or the MAC352.

In one embodiment, the first signal in the present application is generated by the PHY301 or the PHY351.

In one embodiment, the first DCI in the present application is generated by the PHY301 or the PHY351.

In one embodiment, the second DCI in the present application is generated by the PHY301 or the PHY351.

### Embodiment 4

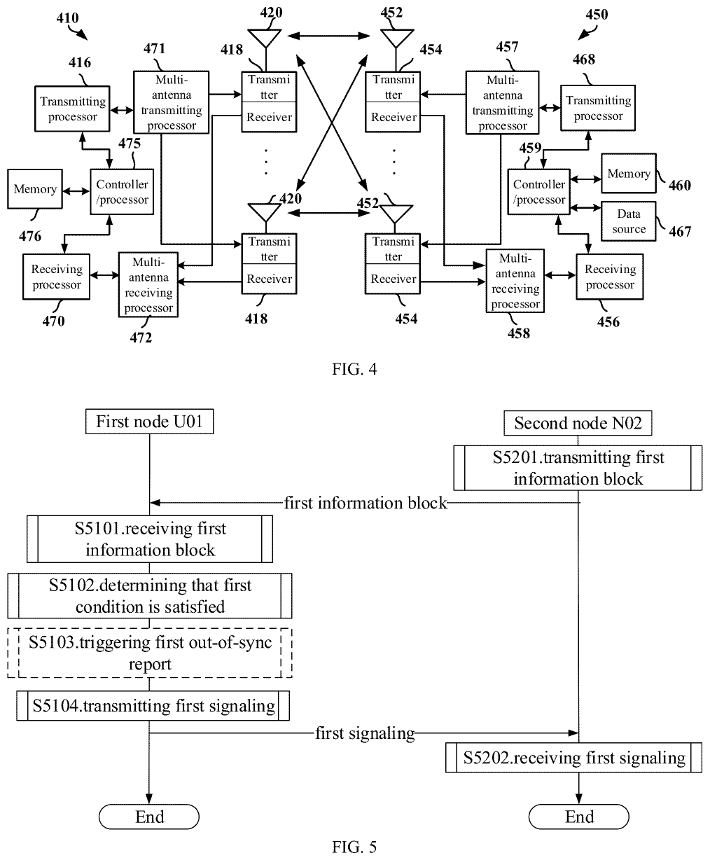

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first information block, the first information block being used to determine a first resource block; and transmits a first signaling in the first resource block, the first signaling being used to indicate a first index; herein, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, the first communication device 450 comprises a memory that stores a computer readable instruction program. The computer readable instruction program generates actions when executed by at least one processor. The actions include: receiving a first information block, the first information block being used to determine a first resource block; and transmitting a first signaling in the first resource block, the first signaling being used to indicate a first index; herein, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, the first communication device 450 comprises at least one processor and at least one memory. The at least one memory comprises computer program codes; the at least one memory and the computer program codes are configured to be used in collaboration with the at least one processor. The first communication device 450 at least triggers a first out-of-sync report as a response to that the first condition is satisfied; the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised; that the first out-of-sync report is satisfied is used to trigger a first signaling; the first signaling being used to indicate a first index; the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, the first communication device 450 comprises a memory that stores a computer readable instruction program. The computer readable instruction program generates an action when executed by at least one processor. The action includes: triggering a first out-of-sync report as a response to that the first condition is satisfied; the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised; that the first out-of-sync report is satisfied is used to trigger a first signaling; the first signaling being used to indicate a first index; the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first information block, the first information block being used to determine a first resource block; and receives a first signaling in the first resource block, the first signaling being used to indicate a first index; herein, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, the second communication device 410 comprises a memory that stores a computer readable instruction program. The computer readable instruction program generates actions when executed by at least one processor. The actions include: transmitting a first information block, the first information block being used to determine a first resource block; and receiving a first signaling in the first resource block, the first signaling being used to indicate a first index; herein, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, the antenna 452, the receiver 454, the receiving processor 456 and the controller/processor 459 are used for receiving a first information block; at least one of the antenna 420, the transmitter 418, the transmitting processor 416 or the controller/processor 475 is used for transmitting a first information block.

In one embodiment, the antenna 452, the receiver 454, the receiving processor 456 and the controller/processor 459 are used for receiving a first DCI; at least one of the antenna 420, the transmitter 418, the transmitting processor 416 or the controller/processor 475 is used for transmitting a first DCI.

In one embodiment, the antenna 452, the receiver 454, the receiving processor 456 and the controller/processor 459 are used for receiving a second DCI; at least one of the antenna 420, the transmitter 418, the transmitting processor 416 or the controller/processor 475 is used for transmitting a second DCI.

In one embodiment, the antenna 452, the transmitter 454, the transmitting processor 468 and the controller/processor 459 are used for transmitting a first signaling; at least one of the antenna 420, the receiver 418, the receiving processor 470 or the controller/processor 475 is used for receiving a first signaling.

In one embodiment, the antenna 452, the transmitter 454, the transmitting processor 468 and the controller/processor 459 are used for transmitting a first signal; at least one of the antenna 420, the receiver 418, the receiving processor 470 or the controller/processor 475 is used for receiving a first signal.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a UE supporting large delay difference.

In one embodiment, the first communication device 450 is a UE supporting NTN.

In one embodiment, the first communication device 450 is an aircraft.

In one embodiment, the first communication device 450 is capable of positioning.

In one embodiment, the first communication device 450 is incapable of positioning.

In one embodiment, the first communication device 450 is a UE supporting TN.

In one embodiment, the second communication device 410 is a base station (gNB/eNB/ng-eNB).

In one embodiment, the second communication device 410 is a base station supporting large delay difference.

In one embodiment, the second communication device 410 is a base station supporting NTN.

In one embodiment, the second communication device 410 is satellite equipment.

In one embodiment, the second communication device 410 is a flight platform.

In one embodiment, the second communication device 410 is a base station supporting TN.

### Embodiment 5

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 receives a first information block in step S5101, the first information block being used to determine a first resource block; and determines in step S5102 that a first condition is satisfied, that the first condition is satisfied being used to trigger the first signaling; and in step S5103 triggers a first out-of-sync report as a response to that the first condition is satisfied; and transmits a first signaling in the first resource block in step S5104, the first signaling being used to indicate a first index.

The second node N02 transmits the first information block in step S5201, and receives the first signaling in step S5202.

In Embodiment 5, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised; the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised; the first out-of-sync report being used to trigger the first signaling.

In one embodiment, the second node N02 comprises at least two TRPs.

In one subembodiment, each of the at least two TRPs is associated to a Distributed Unit (DU), each DU belonging to a Centralized Unit (CU).

In one subembodiment, the at least two TRPs are associated to a DU, the DU belonging to a CU.

In one subembodiment, the at least two TRPs belong to a same cell.

In one subembodiment, the at least two TRPs belong to cells identified by different PCIs, respectively.

In one subembodiment, there are at least two TRPs among the at least two TRPs belonging to cells identified by different PCIs.

In one subembodiment, the at least two TRPs include 2 TRPs.

In one subembodiment, the at least two TRPs include more than 2 TRPs.

In one subembodiment, any two TRPs of the at least two TRPs have different amounts of timing advance.

In one subembodiment, at least two TRPs among the at least two TRPs have different amounts of timing adjustment.

In one embodiment, the second node N02 is a base station.

In one embodiment, the phrase that the first condition is satisfied being used to trigger the first signaling includes that the first condition being satisfied is used to determine transmitting of the first signaling.

In one embodiment, the phrase that the first condition is satisfied being used to trigger the first signaling includes that the first condition being satisfied is used to determine generating of the first signaling.

In one embodiment, the phrase that the first condition is satisfied being used to trigger the first signaling includes generating the first signaling after the first condition is satisfied.

In one embodiment, the phrase that the first condition is satisfied being used to trigger the first signaling includes transmitting the first signaling after the first condition is satisfied.

In one embodiment, the phrase that the first condition is satisfied being used to trigger the first signaling includes that the action of transmitting the first signaling is triggered by the first condition being satisfied.

In one embodiment, as a response to determining that the first condition is satisfied, the first signaling is triggered.

In one embodiment, if the first condition is satisfied, the first signaling is triggered.

In one embodiment, when the first condition is satisfied, the first signaling is triggered.

In one embodiment, expiration of the first timer is used to determine that the first condition is satisfied.

In one embodiment, the first condition being satisfied includes expiration of the first timer.

In one embodiment, the first condition includes expiration of the first timer.

In one embodiment, the first condition is expiration of the first timer.

In one embodiment, the first timer is associated to the first index.

In one embodiment, the first timer is associated to a TAG to which a reference signal resource corresponding to the first index belongs.

In one embodiment, the first condition being satisfied is used to trigger a first out-of-sync report and the first out-of-sync report is used to trigger the first signaling.

In one embodiment, the phrase as a response to that the first condition is satisfied comprises: when the first condition is satisfied.

In one embodiment, the phrase as a response to that the first condition is satisfied comprises: if the first condition is satisfied.

In one embodiment, the first out-of-sync report is triggered at a MAC layer.

In one embodiment, the first out-of-sync report is an out-of-sync report.

In one embodiment, the first out-of-sync report is used to indicate that an uplink transmission associated with a reference signal resource corresponding to the first index is non-synchronised.

In one embodiment, an out-of-sync report is an uplink out-of-sync report.

In one embodiment, an out-of-sync report is a synchronisation report.

In one embodiment, an out-of-sync report is used to indicate that an uplink transmission associated with a reference signal resource corresponding to the one index is non-synchronised.

In one embodiment, the phrase the first out-of-sync report being used to trigger the first signaling includes: generating the first signaling as a response to the first out-of-sync report being triggered.

In one embodiment, a first out-of-sync report is triggered as a response to that the first condition is satisfied; the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised; that the first out-of-sync report is satisfied is used to trigger a first signaling; the first signaling being used to indicate a first index; the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, as a response to the first condition being satisfied, the first out-of-sync report is triggered; the step S5103 exists.

In one embodiment, as a response to the first condition being satisfied, the first out-of-sync report is not triggered; the step S5103 does not exist.

In one embodiment, one condition in the first condition set includes that the first timer expires.

In one embodiment, one condition in the first condition set includes that the first timer expires and a second timer does not expire.

In one embodiment, one condition in the first condition set includes that a change in a measurement result of the reference signal resource corresponding to the first index over a given time interval exceeds a threshold.

In one embodiment, one condition in the first condition set includes that a change in a measurement result of the reference signal resource corresponding to the first index over a given time interval exceeds a threshold and that a second timer does not expire.

In one embodiment, one condition in the first condition set includes that an offset of a crystal oscillator associated with the reference signal resource corresponding to the first index over a given time interval exceeds a threshold.

In one embodiment, one condition in the first condition set includes that an offset of a crystal oscillator associated with the reference signal resource corresponding to the first index over a given time interval exceeds a threshold and that a second timer does not expire.

In one embodiment, the state of the second timer is used to determine whether an uplink transmission associated with a reference signal resource corresponding to the second index is synchronised.

In one subembodiment, the second timer is a timeAlignmentTimer.

In one subembodiment, the second timer is a TAT.

In one subembodiment, the first index is associated to a first TRP, while the second index is associated to a second TRP, the first TRP and the second TRP belonging to a SpCell.

In one subembodiment, a TAG indicated by the first index includes a first TRP, while a TAG indicated by the second index includes a second TRP, the first TRP and the second TRP belonging to a SpCell.

In one subembodiment, a TAG indicated by the first index includes a first TRP, while a TAG indicated by the second index includes a second TRP, the first TRP belonging to the first cell, and the second TRP belonging to the second cell.

### Embodiment 6

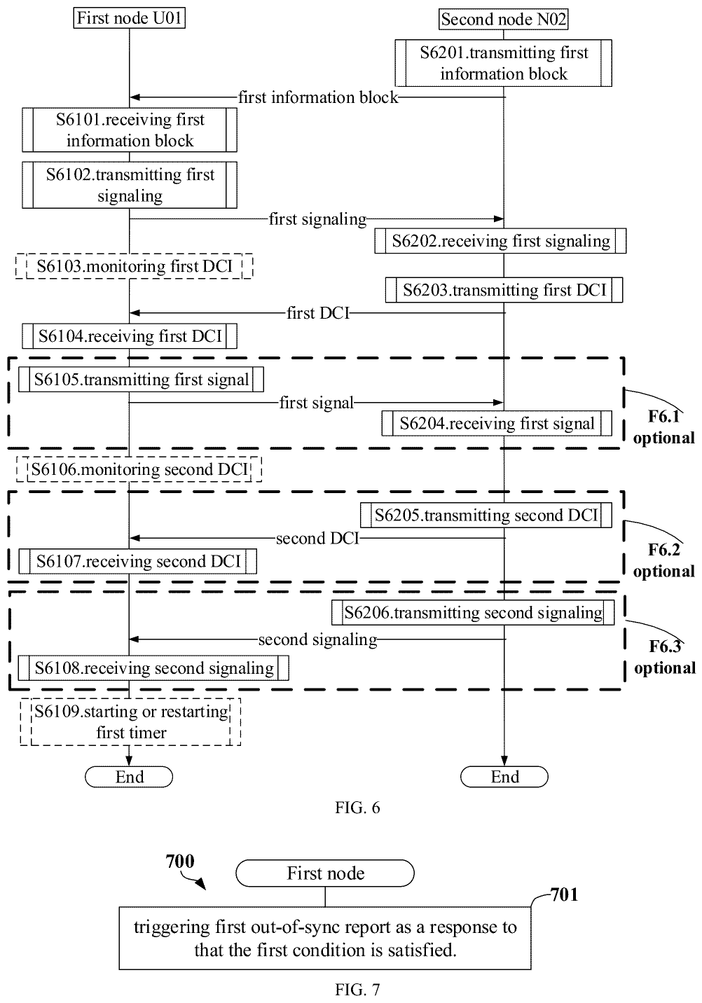

Embodiment 6 illustrates a flowchart of signal transmission according to another embodiment of the present application, as shown in FIG. 6. It should be particularly noted that the sequence illustrated herein does not set any limit to the signal transmission order or implementation order in the present application.

The first node U01 receives a first information block in step S6101, the first information block being used to determine a first resource block; and transmits a first signaling in the first resource block in step S6102, the first signaling being used to indicate a first index; and in step S6103, monitors the first DCI as a response to the first signaling being transmitted; and receives a first DCI in step S6104, the first DCI being used to indicate a first reference signal resource, the first reference signal resource being used for a first random access procedure; in step S6105, transmits a first signal according to the first DCI, the first signal including a random access preamble; in step S6106, monitors a second DCI as a response to the first signal being transmitted; receives the second DCI in step S6107; receives the second signaling in step S6108; and starts or restarts the first timer in step S6109.

The second node N02 transmits the first information block in step S6201; receives the first signaling in step S6202; transmits the first DCI in step S6203; receives the first signal in step S6204; transmits the second DCI in step S6205; and transmits the second signaling in step S6206.

In Embodiment 6, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised; the first reference signal resource is associated with the first index; the first DCI is a physical layer signaling; the first signal and the second DCI belong to the first random access procedure; the second DCI is a physical layer signaling.

In one embodiment, the meaning of monitoring includes to monitor.

In one embodiment, the meaning of monitoring includes to search.

In one embodiment, the meaning of monitoring includes to monitor.

In one embodiment, the meaning of monitoring includes to check by means of Cyclic Redundancy Check (CRC).

In one embodiment, monitoring the first DCI during the time while a second time window is running.

In one embodiment, receiving the first DCI during the time while a second time window is running.

In one embodiment, the second time window belongs to a MAC layer.

In one embodiment, the second time window belongs to a physical layer.

In one embodiment, the second time window's expiration is used to determine a re-transmission of a signaling, the signaling being of the same type as the first signaling.

In one subembodiment, the signaling and the first signaling have a same MAC subheader.

In one subembodiment, the signaling and the first signaling are associated to a same LCID.

In one subembodiment, the signaling and the first signaling have a same MAC field.

In one embodiment, the second time window is defined.

In one embodiment, the second time window is not defined.

In one embodiment, the first reference signal resource is an SS/PBCH.

In one embodiment, the first reference signal resource is an SSB.

In one embodiment, the first reference signal resource is associated to the first random access procedure.

In one embodiment, the first reference signal resource is used for the first signal.

In one embodiment, the first reference signal resource is used for a random access preamble in the first signal.

In one embodiment, the first reference signal resource is used to determine a random access preamble of the first random access procedure.

In one embodiment, the first reference signal resource is used to determine a RACH occasion for a Physical Random Access Channel (PRACH) transmission of the first random access procedure.

In one embodiment, the sentence “the first DCI being used to indicate a first reference signal resource, the first reference signal resource being used for a first random access procedure” includes that the first DCI is used to initiate the first random access procedure.

In one embodiment, the sentence “the first DCI being used to indicate a first reference signal resource, the first reference signal resource being used for a first random access procedure” includes that the first DCI is used to trigger the first random access procedure.

In one embodiment, the first DCI explicitly indicates the first reference signal resource.

In one embodiment, the first DCI implicitly indicates the first reference signal resource.

In one embodiment, the sentence “the first DCI being used to indicate a first reference signal resource, the first reference signal resource being used for a first random access procedure” includes that the first DCI comprises an Identifier for DCI formats field and a Frequency domain resource assignment field, the Identifier for DCI formats field is set to 1 and the Frequency domain resource assignment field is set to all ones; that the Identifier for DCI formats field is set to 1 and the Frequency domain resource assignment field is set to all ones is used to determine that the first DCI is used to indicate a first reference signal resource, the first reference signal resource being used for a first random access procedure.

In one embodiment, the Random Access Preamble index field is set to all zeros.

In one embodiment, the Random Access Preamble index field is not set to all zeros.

In one embodiment, the first DCI is used to indicate how to determine a first reference signal resource.

In one embodiment, the first DCI indicates determination of the first reference signal resource according to the first DCI.

In one subembodiment, a Random Access Preamble index field in the first DCI is not set to all zeros.

In one subembodiment, an SS/PBCH index field in the first DCI indicates the first reference signal resource, the first reference signal resource being an SS/PBCH.

In one embodiment, the first DCI indicates that the first reference signal resource is determined by the first node U01.

In one subembodiment, a Random Access Preamble index field in the first DCI is set to all zeros.

In one subembodiment, the UE determines the first reference signal resource based on RSRP.

In one subembodiment, if SS-RSRP of each SSB of at least one SSB is higher than a rsrp-ThresholdSSB, the UE selects one SSB out of the at least one SSB as the first reference signal resource.

In one subembodiment, if none of SSBs has an SS-RSRP higher than a rsrp-ThresholdSSB, the UE selects any of the SSBs as the first reference signal resource.

In one embodiment, the first reference signal resource belongs to a TRP indicated by the first index.

In one embodiment, the first reference signal resource belongs to a SpCell in a TAG indicated by the first index.

In one embodiment, the first index is associated to a SpCell.

In one embodiment, the first DCI is used to schedule a PDSCH.

In one embodiment, the first DCI is downlink control information.

In one embodiment, the first DCI is a DCI.

In one embodiment, the first DCI comprises a DCI format 1_0.

In one embodiment, the first DCI comprises a DCI format 1_1.

In one embodiment, the first DCI comprises a DCI format 1_2.

In one embodiment, Cyclic Redundancy Check (CRC) of the first DCI is scrambled by a Cell Radio Network Temporary Identifier (C-RNTI).

In one embodiment, the CRC of the first DCI is scrambled by a Configured Scheduling RNTI (CS-RNTI).

In one embodiment, the CRC of the first DCI is scrambled by a Modulation and Coding Scheme RNTI (MCS-RNTI).

In one embodiment, the first DCI is a PDCCH order.

In one embodiment, the first DCI is used for a random access procedure initiated by a PDCCH order.

In one embodiment, the first DCI comprises a Random Access Preamble index field, the Random Access Preamble index field being used to indicate a Random Access Preamble (ra-PreambleIndex).

In one embodiment, the first DCI comprises a UL/SUL indicator field; the UL/SUL indicator field indicates an uplink carrier for transmitting a PRACH only if the Random Access Preamble index field is not set to all zeros.

In one embodiment, the first DCI comprises an SS/PBCH index field; only when the Random Access Preamble index field is not set to all zeros, the SS/PBCH index field indicates an SS/PBCH, and the SS/PBCH is used to determine a RACH occasion for a PRACH transmission.

In one embodiment, the first DCI comprises a PRACH Mask index field; only when the Random Access Preamble index field is not set to all zeros, the PRACH Mask index field indicates a RACH occasion for a PRACH transmission, the RACH occasion for the PRACH transmission being associated to the SS/PBCH.

In one embodiment, the random access preamble is a bit string.

In one embodiment, the action of transmitting a first signal according to the first DCI comprises: determining at least a Random Access Preamble in the first signal according to the first DCI.

In one embodiment, the action of transmitting a first signal according to the first DCI comprises: determining the first signal according to the first DCI, the first signal being a Random Access Preamble.

In one embodiment, the action of transmitting a first signal according to the first DCI comprises: determining at least one of a time domain resource, a frequency domain resource, a code domain resource, or a spatial domain resource for the first signal according to the first DCI.

In one embodiment, the action of transmitting a first signal according to the first DCI comprises: transmitting the first signal according to a parameter indicated by the first DCI.

In one embodiment, the action of transmitting a first signal according to the first DCI comprises: the first signal being transmitted on a wireless resource indicated by the first DCI.

In one embodiment, the action of transmitting a first signal according to the first DCI comprises: determining, according to the first DCI, a wireless resource being used to carry the first signal.

In one embodiment, determining at least one of a random access preamble, or an uplink carrier used for a PRACH transmission, or a RACH occasion for a PRACH transmission, or a RACH occasion for a PRACH transmission, according to the first DCI.

In one embodiment, determining a random access preamble according to the first DCI.

In one embodiment, selecting an uplink carrier used for a PRACH transmission according to the first DCI.

In one embodiment, determining an SS/PBCH according to the first DCI, the SS/PBCH being used to determine a RACH occasion for a PRACH transmission.

In one embodiment, determining a RACH occasion for a PRACH transmission according to the first DCI, the RACH occasion for the PRACH transmission being associated to the SS/PBCH.

In one embodiment, the second DCI is used to schedule a PDSCH.

In one embodiment, the second DCI is downlink control information.

In one embodiment, the second DCI is a DCI.

In one embodiment, the second DCI comprises a DCI format 1_0.

In one embodiment, the second DCI comprises a DCI format 1_1.

In one embodiment, the second DCI comprises a DCI format 1_2.

In one embodiment, CRC of the second DCI is scrambled by a C-RNTI.

In one embodiment, CRC of the second DCI is scrambled by a RA-RNTI.

In one embodiment, CRC of the second DCI is scrambled by a MSGA-RNTI.

In one embodiment, the second DCI is used to indicate physical layer scheduling information for RAR.

In one embodiment, the second DCI is used to indicate an amount of timing advance.

In one embodiment, a PDCCH used for carrying the second DCI has the same quasi co-location characteristics as a PDCCH used for carrying the first DCI.

In one embodiment, a PDCCH used for carrying the second DCI has different quasi co-location characteristics from a PDCCH used for carrying the first DCI.

In one embodiment, a PDCCH used for carrying the second DCI has the same DM-RS antenna port quasi co-location characteristics as a PDCCH used for carrying the first DCI.

In one embodiment, a PDCCH used for carrying the second DCI has different DM-RS antenna port quasi co-location characteristics from a PDCCH used for carrying the first DCI.

In one embodiment, the first signal is used to trigger the second DCI.

In one embodiment, receiving the second DCI as a response to the first signal being transmitted.

In one embodiment, monitoring the second DCI as a response to the first signal being transmitted.

In one embodiment, each field in this application comprises at least one bit.

In one embodiment, a field being set to all ones means that each bit in the field is set to 1.

In one embodiment, a field being set to all zeros means that each bit in the field is set to 0.

In one embodiment, the step S6103 is optional.

In one embodiment, the step S6103 exists.

In one embodiment, the step S6103 does not exist.

In one embodiment, the step S6106 is optional.

In one embodiment, the step S6106 exists.

In one subembodiment, monitoring the second DCI via a RA-RNTI.

In one subembodiment, monitoring the second DCI via a MSGA-RNTI.

In one subembodiment, monitoring the second DCI within a first time window as a response to the first signal being transmitted.

In one subembodiment, the first time window belongs to a MAC layer.

In one subembodiment, the first time window is a ra-ResponseWindow.

In one subembodiment, the first time window is a msgB-ResponseWindow.

In one subembodiment, that the first time window expires and PREAMBLE_TRANSMISSION_COUNTER is less than preambleTransMax+1 is used to determine retransmitting of a random access preamble.

In one subembodiment, that the first time window expires and PREAMBLE_TRANSMISSION_COUNTER is not less than preambleTransMax+1 deems that the first random access procedure has not been successfully completed; where a random access preamble included in the first signal is transmitted on an SCell.

In one subembodiment, that the first time window expires and PREAMBLE_TRANSMISSION_COUNTER is not less than preambleTransMax+1 is used to determine indicating to a higher layer a random access problem; where a random access preamble included in the first signal is transmitted on a SpCell.

In one embodiment, the step S6106 does not exist.

In one embodiment, the dashed-line box F6.1 is optional.

In one embodiment, the dashed-line box F6.1 exists.

In one embodiment, at least part of the dashed-line box F6.1 does not exist.

In one subembodiment, the dashed-line box F6.2, the dashed-line box F6.3, the step S6106 and the step S6109 are absent.

In one subembodiment, the first signal is not transmitted.

In one subembodiment, the first signal is transmitted, and the first signal is not received by the second node N02.

In one embodiment, the dashed-line box F6.2 is optional.

In one embodiment, the dashed-line box F6.2 exists.

In one subembodiment, the dashed-line box F6.1 and the step S6106 are present.

In one subembodiment, the dashed-line box F6.3 exists.

In one subsidiary embodiment of the above subembodiment, as a response to the second DCI being received, the second signaling is received according to the second DCI.

In one subembodiment, the dashed-line box F6.3 does not exist.

In one subsidiary embodiment of the above subembodiment, as a response to the second DCI being received, the first random access procedure is successfully completed; where a Random Access Preamble index field in the first DCI is not set to all zeros.

In one subsidiary embodiment of the above subembodiment, the second signaling is not successfully received.

In one subsidiary embodiment of the above subembodiment, the second signaling is not transmitted.

In one embodiment, at least part of the dashed-line box F6.2 does not exist.

In one subembodiment, neither of the dashed-line box F6.3 and the step S6109 are present.

In one subembodiment, the second DCI is not transmitted.

In one subembodiment, the second DCI is not successfully received.

In one subembodiment, the first time window expires.

In one embodiment, the dashed-line box F6.3 is optional.

In one embodiment, the dashed-line box F6.3 does not exist.

In one embodiment, the dashed-line box F6.3 is present.

In one subembodiment, the dashed-line box F6.1, the dashed-line box F6.2 and the step S6106 are present.

In one subembodiment, as a response to the second signaling being received, the first random access procedure is successfully completed; where a Random Access Preamble index field in the first DCI is not set to all zeros.

In one subembodiment, as a response to the second signaling being received, Msg3 is transmitted, the Msg3 including a C-RNTI MAC CE, the C-RNTI MAC CE including a C-RNTI; as a response to the Msg3 being transmitted, Msg4 is received, the CRC of the Msg4 being scrambled by the C-RNTI; as a response to the Msg4 being received, the first random access procedure is successfully completed; where a Random Access Preamble index field in the first DCI is set to all zeros.

In one embodiment, the step S6109 is optional.

In one embodiment, the step S6109 does not exist.

In one embodiment, the step S6109 exists.

In one subembodiment, the action of starting or restarting the first timer comprises: starting the first timer if the first timer is not running.

In one subembodiment, the action of starting or restarting the first timer comprises: restarting the first timer if the first timer is running.

In one subembodiment, the action of starting or restarting the first timer comprises: starting the first timer from 0.

In one subembodiment, the action of starting the first timer means that the first timer starts timing.

In one subembodiment, the action of starting the first timer means that the first timer restarts timing.

In one subembodiment, the second DCI is used to indicate a first amount of timing adjustment, or, the second signaling is used to indicate the first amount of timing adjustment.

In one subembodiment, as a response to the second DCI being received, starting or restarting the first timer; the second DCI is used to indicate the first amount of timing adjustment.

In one subsidiary embodiment of the above subembodiment, the dashed-line box F6.2 is present and the dashed-line box F6.3 is not present, or, both the dashed-line box F6.2 and the dashed-line box F6.3 are present.

In one subsidiary embodiment of the above subembodiment, the CRC of the second DCI is scrambled by a C-RNTI.

In one subsidiary embodiment of the above subembodiment, the CRC of the second DCI is scrambled by a CS-RNTI.

In one subsidiary embodiment of the above subembodiment, the CRC of the second DCI is scrambled by a MCS-RNTI.

In one subsidiary embodiment of the above subembodiment, the second DCI includes a DCI field being used to indicate the first amount of timing adjustment.

In one subsidiary embodiment of the above subembodiment, the second DCI includes a Timing Advance Command field being used to indicate the first amount of timing adjustment.

In one subsidiary embodiment of the above subembodiment, as a response to the second DCI being received, a physical layer of the first node U01 sends an indication to a MAC layer of the first node U01; and as a response to the indication being received, starting or restarting the first timer; where the second DCI is used to indicate the first amount of timing adjustment.

In one subembodiment, as a response to the second signaling being received, starting or restarting the first timer; the second signaling is used to indicate the first amount of timing adjustment.

In one subsidiary embodiment of the above subembodiment, both of the dashed-line box F6.2 and the dashed-line box F6.3 are present.

In one subsidiary embodiment of the above subembodiment, the second DCI is used to indicate physical layer scheduling information for a PDSCH, the PDSCH being used to carry the second signaling.

In one subsidiary embodiment of the above subembodiment, the second DCI comprises a DCI format 1_0.

In one subsidiary embodiment of the above subembodiment, the CRC of the second DCI is scrambled by a RA-RNTI.

In one subsidiary embodiment of the above subembodiment, the CRC of the second DCI is scrambled by a MSGA-RNTI.

In one subsidiary embodiment of the above subembodiment, the physical layer scheduling information includes at least one of a time-domain location, a frequency-domain location, a Modulation and coding scheme (MCS), a VRB (i.e., Virtual resource block)-to-PRB (i.e., Physical resource block) mapping, TB (i.e., Transmission Block) Scaling, or LSB of a System Frame Number (SFN).

In one subsidiary embodiment of the above subembodiment, the time-domain location is indicated by a Time domain resource assignment field.

In one subsidiary embodiment of the above subembodiment, the frequency-domain location is indicated by a Frequency domain resource assignment field.

In one subsidiary embodiment of the above subembodiment, the MCS is indicated by a Modulation and coding scheme field.

In one subsidiary embodiment of the above subembodiment, the VRB-to-PRB mapping is configured via a VRB-to-PRB mapping field.

In one subsidiary embodiment of the above subembodiment, the TB Scaling is indicated via TB scaling.

In one subsidiary embodiment of the above subembodiment, the LSB of the SFN are indicated via a LSBs of SFN field.

In one subsidiary embodiment of the above subembodiment, the second signaling includes a DCI field being used to indicate the first amount of timing adjustment.

In one subsidiary embodiment of the above subembodiment, the second signaling includes a Timing Advance Command field being used to indicate the first amount of timing adjustment.

In one subsidiary embodiment of the above subembodiment, the second signaling includes a MAC RAR.

In one subsidiary embodiment of the above subembodiment, the second signaling includes a fallbackRAR.

In one subsidiary embodiment of the above subembodiment, the second signaling includes a successRAR.

In one subsidiary embodiment of the above subembodiment, the second signaling includes a Timing Advance Command MAC CE.

In one subsidiary embodiment of the above subembodiment, the second signaling includes an Absolute Timing Advance Command MAC CE.

In one subsidiary embodiment of the above subembodiment, if having received the second signaling, starting or restarting the first timer.

In one subsidiary embodiment of the above subembodiment, when receiving the second signaling, starting or restarting the first timer.

In one subsidiary embodiment of the above subembodiment, receiving the second signaling is used to trigger starting or restarting of the first timer.

In one subsidiary embodiment of the above subembodiment, receiving the second signaling is used to trigger starting or restarting of the first timer.

In one subsidiary embodiment of the above subembodiment, the second signaling includes a MAC subheader, and the MAC subheader includes a RAPID field, the RAPID field indicating an index of a random access preamble in the first signal.

### Embodiment 7

Embodiment 7 illustrates a flowchart of a first out-of-sync report according to one embodiment of the present application, as shown in FIG. 7. In FIG. 7, each step represents a step, it should be particularly noted that the sequence order of each box herein does not imply a chronological order of steps marked respectively by these boxes.

In Embodiment 7, the first node in the present application triggers a first out-of-sync report as a response to that the first condition is satisfied; herein, the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised; that the first out-of-sync report is satisfied is used to trigger a first signaling; the first signaling being used to indicate a first index; the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, the first signaling is transmitted.

In one subembodiment, the first out-of-sync report is canceled as a response to the first signaling being transmitted.

In one subembodiment, the first out-of-sync report is not canceled as a response to the first signaling being transmitted.

In one embodiment, the first signaling is not transmitted.

In one embodiment, the first DCI in the present application is received.

In one subembodiment, the first out-of-sync report is canceled as a response to the first DCI being received.

In one subembodiment, the first out-of-sync report is not canceled as a response to the first DCI being received.

In one embodiment, the first DCI in the present application is not received.

In one embodiment, the first timing advance command in the present application is received.

In one subembodiment, the first out-of-sync report is canceled as a response to the first timing advance command in the present application being received.

In one subembodiment, the first out-of-sync report is not canceled as a response to the first timing advance command in the present application being received.

In one embodiment, the first timing advance command in the present application is not received.

### Embodiment 8

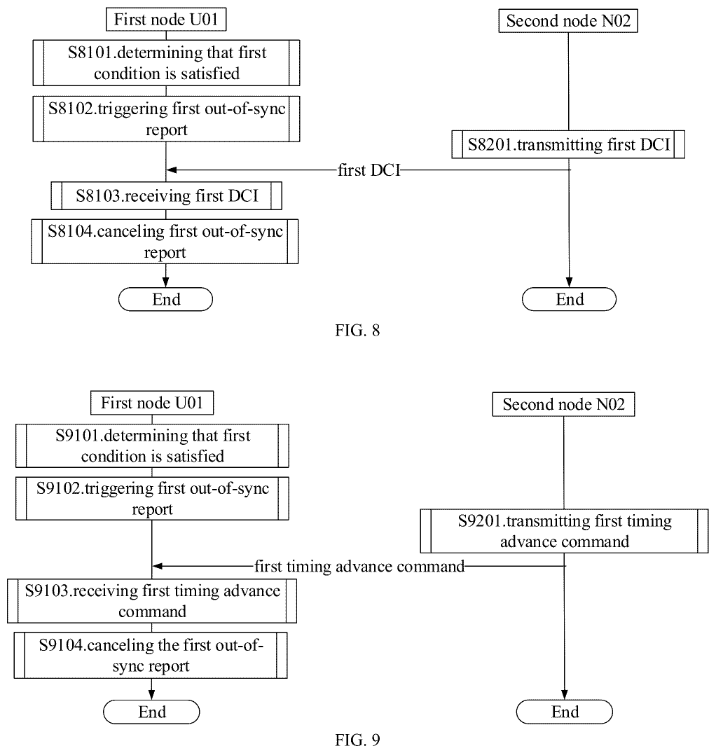

Embodiment 8 illustrates a flowchart of radio signal transmission of canceling a first out-of-sync report according to one embodiment of the present application, as shown in FIG. 8. It should be particularly noted that the sequence illustrated herein does not set any limit to the signal transmission order or implementation order in the present application.

The first node U01 determines that a first condition is satisfied in step S8101; and in step S8102, triggers a first out-of-sync report as a response to that the first condition is satisfied; and in step S8103, receives a first DCI, the first DCI being used to indicate a first reference signal resource, the first reference signal resource being used for a first random access procedure; and in step S8104, cancels the first out-of-sync report as a response to the first DCI being received.

The second node N02 transmits the first DCI in step S8201.

In Embodiment 8, the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised; that the first out-of-sync report is satisfied is used to trigger a first signaling; the first signaling being used to indicate a first index; the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised; the first reference signal resource is associated with the first index; the first DCI is a physical layer signaling.

In one embodiment, the first information block in the present application is received.

In one embodiment, the first information block in the present application is not received.

In one embodiment, the first signaling in the present application is not transmitted.

In one embodiment, receiving the first DCI after the first signaling has been transmitted.

In one embodiment, the first signaling is used to trigger the first DCI.

In one embodiment, the first signaling is not transmitted when the first DCI is received.

In one embodiment, the first signaling is transmitted when the first DCI is received.

In one embodiment, the first DCI is determined to be transmitted by the second node N02.

In one embodiment, the second node N02 detecting a non-synchronisation in an uplink transmission associated with a reference signal resource corresponding to the first index is used to determine transmitting of the first DCI.

In one embodiment, the second node N02 receiving the first signaling is used to determine transmitting of the first DCI.

In one embodiment, upon reception of the first DCI, the first out-of-sync report is triggered and the first out-of-sync report is in a pending state.

In one embodiment, upon reception of the first DCI, the first out-of-sync report is triggered and the first information block is not received.

In one embodiment, upon reception of the first DCI, the first out-of-sync report is triggered and the first resource block cannot hold the first signaling; the first signaling comprises a MAC CE and a MAC subheader.

In one embodiment, upon reception of the first DCI, the first out-of-sync report is triggered and, according to the result of Logical Channel Prioritization (LCP), the first resource block cannot hold the first signaling; the first signaling comprises a MAC CE and a MAC subheader.

In one embodiment, the action “canceling the first out-of-sync report as a response to the first DCI being received” comprises: canceling the first out-of-sync report when the first DCI is received.

In one embodiment, the action “canceling the first out-of-sync report as a response to the first DCI being received” comprises: canceling the first out-of-sync report when the first DCI is received.

### Embodiment 9

Embodiment 9 illustrates a flowchart of radio signal transmission of canceling a first out-of-sync report according to another embodiment of the present application, as shown in FIG. 9. It should be particularly noted that the sequence illustrated herein does not set any limit to the signal transmission order or implementation order in the present application.

The first node U01 determines that a first condition is satisfied in step S9101; and in step S9102, triggers a first out-of-sync report as a response to that the first condition is satisfied; and in step S9103, receives a first timing advance command; and in step S9104, cancels the first out-of-sync report as a response to the first timing advance command being received.

The second node N02 transmits the first timing advance command in step S9201.

In Embodiment 9, the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised; that the first out-of-sync report is satisfied is used to trigger a first signaling; the first signaling being used to indicate a first index; the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised; the first timing advance command is used to indicate an amount of timing advance being associated with the reference signal resource corresponding to the first index.

In one embodiment, the first information block in the present application is received.

In one embodiment, the first information block in the present application is not received.

In one embodiment, the first signaling in the present application is not transmitted.

In one embodiment, the first signaling in the present application is transmitted.

In one embodiment, the first timing advance command includes an index of an amount of timing adjustment being associated with a reference signal resource corresponding to the first index.

In one embodiment, the first timing advance command includes the first index, and the first timing advance command includes an index of an amount of timing adjustment associated with a reference signal resource corresponding to the first index.

In one embodiment, upon reception of the first timing advance command, the first out-of-sync report is triggered and the first out-of-sync report is in a pending state.

In one embodiment, upon reception of the first timing advance command, the first out-of-sync report is triggered and the first information block is not received.

In one embodiment, upon reception of the first timing advance command, the first out-of-sync report is triggered and the first resource block cannot hold the first signaling and a MAC subheader of the first signaling.

In one embodiment, the first timing advance command comprises a field in a Timing Advance Command MAC CE.

In one embodiment, the first timing advance command comprises a field in a DCI.

In one embodiment, the first timing advance command comprises a field in a MAC CE.

In one embodiment, the first timing advance command comprises a field in a MSGB.

In one embodiment, the first timing advance command comprises a field in a MAC RAR.

In one embodiment, the first timing advance command comprises a field in a fallbackRAR.

In one embodiment, the first timing advance command comprises a Timing Advance Command MAC CE.

In one embodiment, the first timing advance command comprises an Absolute Timing Advance Command MAC CE.

In one embodiment, the first timing advance command comprises a field, the field being a Timing Advance Command field.

In one embodiment, the first timing advance command comprises a field, the field being used to indicate an index value TA of a total amount of timing adjustment.

In one embodiment, the first timing advance command comprises a field, the field being used to indicate an index value TA of a total amount of timing adjustment.

In one embodiment, the above field in the first timing advance command comprises a positive integer number of bits.

In one embodiment, the above field in the first timing advance command comprises 12 bits.

In one embodiment, the above field in the first timing advance command comprises 6 bits.

### Embodiment 10

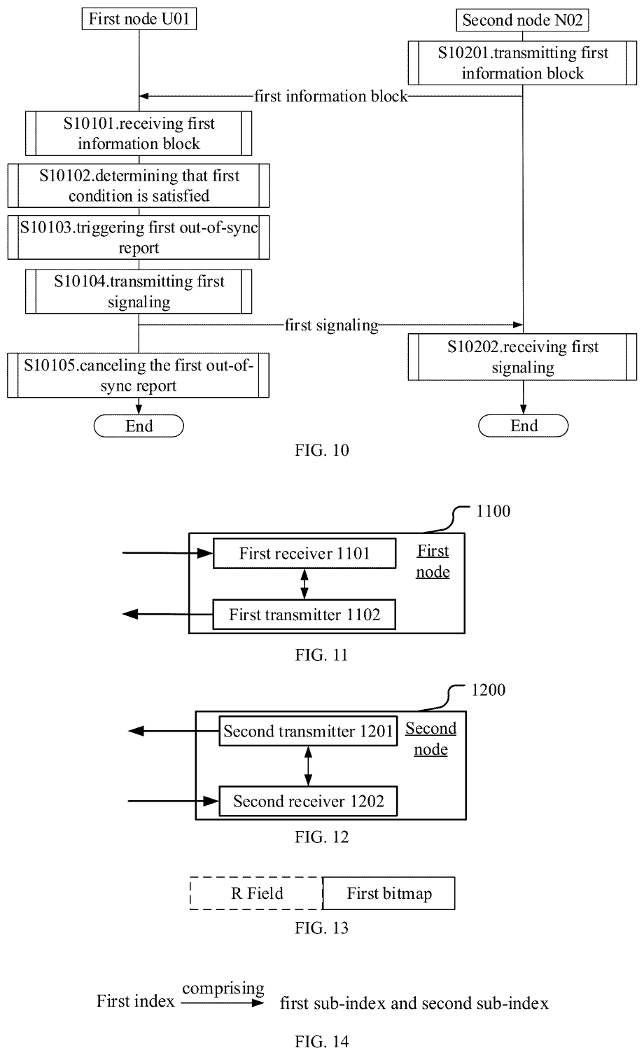

Embodiment 10 illustrates a flowchart of radio signal transmission of canceling a first out-of-sync report according to a third embodiment of the present application, as shown in FIG. 10. It should be particularly noted that the sequence illustrated herein does not set any limit to the signal transmission order or implementation order in the present application.

The first node U01 receives a first information block in step S10101, the first information block being used to determine a first resource block; and determines in step S10102 that a first condition is satisfied; and in step S10103 triggers a first out-of-sync report as a response to that the first condition is satisfied; and transmits a first signaling in the first resource block in step S10104; and in step S10105, cancels the first out-of-sync report as a response to the first signaling being transmitted.

The second node N02 transmits the first information block in step S10201, and receives the first signaling in step S10202.

In Embodiment 10, the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised; that the first out-of-sync report is satisfied is used to trigger a first signaling; the first signaling being used to indicate a first index; the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, the first signaling being transmitted includes that a MAC PDU carrying the first signaling is transmitted.

In one embodiment, the first signaling being transmitted includes that the first signaling is delivered at the MAC layer to the physical layer.

In one embodiment, the first signaling being transmitted includes that the first signaling is transmitted at the physical layer.

### Embodiment 11

Embodiment 11 illustrates a structure block diagram of a processing device used in a first node according to one embodiment of the present application, as shown in FIG. 11. In FIG. 11, a processing device 1100 in a first node is comprised of a first receiver 1101 and a first transmitter 1102.

The first receiver 1101 receives a first information block, the first information block being used to determine a first resource block;

the first transmitter 1102 transmits a first signaling in the first resource block, the first signaling being used to indicate a first index.

In Embodiment 11, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, the first receiver 1101 determines that a first condition is satisfied, that the first condition is satisfied being used to trigger the first signaling; herein, the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised.

In one embodiment, the first receiver 1101 triggers a first out-of-sync report as a response to that the first condition is satisfied; the first out-of-sync report being used to trigger the first signaling.

In one embodiment, the first receiver 1101 receives a first DCI, the first DCI being used to indicate a first reference signal resource, the first reference signal resource being used for a first random access procedure; the first reference signal resource is associated with the first index; the first DCI is a physical layer signaling.

In one embodiment, the first transmitter 1102 transmits a first signal according to the first DCI, the first signal including a random access preamble; the first receiver 1101 monitors a second DCI as a response to the first signal being transmitted;

herein, the first signal and the second DCI belong to the first random access procedure; the second DCI is a physical layer signaling.

In one embodiment, the first transmitter 1102 monitors the first DCI as a response to the first signaling being transmitted.

In one embodiment, the first receiver starts or restarts the first timer as a response to the second DCI being received, or starts or restarts the first timer as a response to the second signaling being received; herein, the second DCI is used to indicate a first amount of timing adjustment; or, the second signaling is used to indicate the first amount of timing adjustment.

In one embodiment, the first receiver 1101 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises the antenna 452, the receiver 454, the multi-antenna receiving processor 458 and the receiving processor 456 in FIG. 4 of the present application.

In one embodiment, the first receiver 1101 comprises the antenna 452, the receiver 454 and the receiving processor 456 in FIG. 4 of the present application.

In one embodiment, the first transmitter 1102 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1102 comprises the antenna 452, the transmitter 454, the multi-antenna transmitting processor 457 and the transmitting processor 468 in FIG. 4 of the present application.

In one embodiment, the first transmitter 1102 comprises the antenna 452, the transmitter 454 and the transmitting processor 468 in FIG. 4 of the present application.

In one embodiment, the first transmitter 1102 comprises at least one transmitter.

In one embodiment, the first receiver 1101 comprises at least one receiver.

### Embodiment 12

Embodiment 12 illustrates a structure block diagram of a processing device used in a second node according to one embodiment of the present application, as shown in FIG. 12. In FIG. 12, a processing device 1200 in a second node is comprised of a second transmitter 1201 and a second receiver 1202.

The second transmitter 1201 transmits a first information block, the first information block being used to determine a first resource block;

the second receiver 1202 receives a first signaling in the first resource block, the first signaling being used to indicate a first index.

In Embodiment 12, the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

In one embodiment, it is determined that a first condition is satisfied, that the first condition is satisfied being used to trigger the first signaling; herein, the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised.

In one embodiment, a first out-of-sync report is triggered as a response to that the first condition is satisfied; the first out-of-sync report being used to trigger the first signaling.

In one embodiment, the second transmitter 1201 transmits a first DCI, the first DCI being used to indicate a first reference signal resource, the first reference signal resource being used for a first random access procedure; the first reference signal resource is associated with the first index; the first DCI is a physical layer signaling.

In one embodiment, the second receiver 1202 receives a first signal, the first signal including a random access preamble; and the second transmitter 1201 transmits a second DCI as a response to the first signal being received; herein, the first signal is transmitted according to the first DCI; the first signal and the second DCI belong to the first random access procedure; the second DCI is a physical layer signaling.

In one embodiment, the first DCI is monitored as a response to the first signaling being transmitted.

In one embodiment, as a response to the second DCI being received, the first timer is started or restarted; or, as a response to the second signaling being received, the first timer is started or restarted; where the second DCI is used to indicate a first amount of timing adjustment; or, the second signaling is used to indicate the first amount of timing adjustment.

In one embodiment, the second transmitter 1201 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1201 comprises the antenna 420, the transmitter 418, the multi-antenna transmitting processor 471 and the transmitting processor 416 in FIG. 4 of the present application.

In one embodiment, the second transmitter 1201 comprises the antenna 420, the transmitter 418 and the transmitting processor 416 in FIG. 4 of the present application.

In one embodiment, the second receiver 1202 comprises the antenna 420, the receiver 418, the multi-antenna receiving processor 472, the receiving processor 470, the controller/processor 475 and the memory 476 in FIG. 4 of the present application.

In one embodiment, the second receiver 1202 comprises the antenna 420, the receiver 418, the multi-antenna receiving processor 472 and the receiving processor 470 in FIG. 4 of the present application.

In one embodiment, the second receiver 1202 comprises the antenna 420, the receiver 418 and the receiving processor 470 in FIG. 4 of the present application.

In one embodiment, the second transmitter 1201 comprises at least one transmitter.

In one embodiment, the second receiver 1202 comprises at least one receiver.

### Embodiment 13

Embodiment 13 illustrates a schematic diagram of a first signaling comprising a first MAC CE according to one embodiment of the present application. In FIG. 13, a solid box indicates a first bitmap and a dashed box indicates a Reserved (R) Field.

In Embodiment 13, the first signaling comprises a first MAC CE, the first MAC CE comprising at least a first bitmap, any bit in the first bitmap indicating a candidate index, the first index being a candidate index in the first bitmap.

In one embodiment, that one bit in the first bitmap is set to 1 is used to indicate that an uplink transmission associated with a reference signal resource corresponding to a candidate index corresponding to the one bit is non-synchronised; that one bit in the first bitmap is set to 0 is used to indicate that an uplink transmission associated with a reference signal resource corresponding to a candidate index corresponding to the one bit is not non-synchronised.

In one embodiment, a bit corresponding to the first index in the first bitmap in the first signaling is set to 1.

In one embodiment, the dashed box is present.

In one embodiment, the dashed box is not present.

In one embodiment, the first MAC CE comprises the first bitmap and a Reserved Field.

In one embodiment, the first MAC CE comprises the first bitmap.

In one embodiment, the first bitmap comprises M bits, each of the M bits indicating a candidate index.

In one embodiment, M is an integer and M1 is not less than 4 and M is not greater than 8.

In one embodiment, M is equal to 4 and the Reserved Field comprises 4 bits.

In one embodiment, M is equal to 5 and the Reserved Field comprises 3 bits.

In one embodiment, M is equal to 6 and the Reserved Field comprises 2 bits.

In one embodiment, M is equal to 7 and the Reserved Field comprises 1 bit.

In one embodiment, M is equal to 8.

In one embodiment, the first bit from the right of the first bitmap indicates a TAG with TAG ID equal to 0, the second bit from the right indicates a TAG with TAG ID equal to 1, and the third bit from the right indicates a TAG with TAG ID equal to 2, . . . and so on; any of the multiple candidate indexes is a TAG ID.

In one embodiment, it is particularly important to emphasize the position of the individual fields in the figure and to limit the positional relationship between the individual fields.

In one embodiment, the first bitmap immediately follows the Reserved Field.

In one embodiment, the Reserved Field immediately follows the first bitmap.

In one embodiment, the first MAC CE comprises an octet.

### Embodiment 14

Embodiment 14 illustrates a schematic diagram of a first index comprising a first sub-index and a second sub-index according to one embodiment of the present application.

In Embodiment 14, the first signaling is used to indicate a first index, the first index comprising a first sub-index and a second sub-index.

In one embodiment, any one of the multiple candidate indexes comprises a first sub-candidate-index and a second sub-candidate-index; the first sub-index is a first sub-candidate-index and the second sub-index is a second sub-candidate-index.

In one embodiment, one field in the first signaling indicates the first sub-index, and another field in the first signaling indicates the second sub-index.

In one embodiment, the first sub-index is a cell identity.

In one embodiment, the first sub-index is used to indicate a cell.

In one embodiment, the first sub-index is used to indicate a cell to which a TRP with an uplink non-synchronisation belongs.

In one embodiment, the first sub-index comprises a Serving Cell ID.

In one embodiment, the first sub-index comprises a ServCellIndex.

In one embodiment, the first sub-index comprises a SCellIndex.

In one embodiment, the second sub-index is a TRP index.

In one embodiment, the second sub-index is used to indicate a TRP.

In one embodiment, the second sub-index is used to indicate a resource group, the resource group being associated to a TRP, the resource group belonging to a cell indicated by the first sub-index.

In one embodiment, the second sub-index is associated with at least one TCI-Stateld.

In one embodiment, the second sub-index is associated with a CORESET Pool ID.

In one embodiment, the second sub-index is associated with at least one CORESET, the at least one CORESET being associated with a TRP.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first information block, the first information block being used to determine a first resource block; and
a first transmitter, transmitting a first signaling in the first resource block, the first signaling being used to indicate a first index;
wherein the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

2. The first node according to claim 1, characterized in comprising:
the first receiver, determining that a first condition is satisfied, that the first condition is satisfied being used to trigger the first signaling;
wherein the first condition is any condition in a first condition set, the first condition set including at least one condition, one condition in the first condition set including expiration of a first timer; a state of the first timer is used to determine whether the uplink transmission being associated with the reference signal resource corresponding to the first index is synchronised.

3. The first node according to claim 2, characterized in that one condition in the first condition set includes that a change in a measurement result of the reference signal resource corresponding to the first index over a given time interval exceeds a threshold.

4. The first node according to claim 2, characterized in that one condition in the first condition set includes that a change in a measurement result of the reference signal resource corresponding to the first index over a given time interval exceeds a threshold and that a second timer does not expire.

5. The first node according to claim 2, characterized in comprising:
the first receiver, triggering a first out-of-sync report as a response to that the first condition is satisfied; that the first out-of-sync report is satisfied being used to trigger the first signaling.

6. The first node according to claim 5, characterized in comprising:
the first receiver, receiving a first timing advance command; and as a response to the first timing advance command being received, canceling the first out-of-sync report;
wherein the first timing advance command is used to indicate an amount of timing advance being associated with the reference signal resource corresponding to the first index.

7. The first node according to claim 5, characterized in comprising:
the first transmitter, canceling the first out-of-sync report as a response to the first signaling being transmitted.

8. The first node according to claim 5, characterized in comprising:
the first receiver, receiving a first DCI, the first DCI being used to indicate a first reference signal resource, the first reference signal resource being used for a first random access procedure; and canceling the first out-of-sync report as a response to the first DCI being received;
wherein the first reference signal resource is associated with the first index; the first DCI is a physical layer signaling.

9. The first node according to claim 1, characterized in comprising:
the first receiver, receiving a first DCI, the first DCI being used to indicate a first reference signal resource, the first reference signal resource being used for a first random access procedure;
wherein the first reference signal resource is associated with the first index; the first DCI is a physical layer signaling.

10. The first node according to claim 9, characterized in comprising:
the first transmitter, transmitting a first signal according to the first DCI, the first signal including a random access preamble; and
the first receiver, monitoring a second DCI as a response to the first signal being transmitted;
wherein the first signal and the second DCI belong to the first random access procedure; the second DCI is a physical layer signaling.

11. The first node according to claim 9, characterized in comprising:
the first transmitter, monitoring the first DCI as a response to the first signaling being transmitted.

12. The first node according to claim 2, characterized in comprising:
the first receiver, receiving a first DCI, the first DCI being used to indicate a first reference signal resource, the first reference signal resource being used for a first random access procedure;
the first transmitter, transmitting a first signal according to the first DCI, the first signal including a random access preamble;
the first receiver, monitoring a second DCI as a response to the first signal being transmitted; and
the first receiver, starting or restarting the first timer as a response to the second DCI being received, or starting or restarting the first timer as a response to the second signaling being received;
wherein the first reference signal resource is associated with the first index; the first DCI is a physical layer signaling; the first signal and the second DCI belong to the first random access procedure; the second DCI is a physical layer signaling; the second DCI is used to indicate a first amount of timing adjustment; or, the second signaling is used to indicate the first amount of timing adjustment.

13. The first node according to claim 1, characterized in that the first signaling comprises a UCI, a field of the UCI indicating the first index;
or,
the first signaling comprises a MAC CE, a field of the MAC CE indicating the first index.

14. The first node according to claim 1, characterized in that any of the multiple candidate indexes indicates a TAG.

15. A method in a first node for wireless communications, comprising:
receiving a first information block, the first information block being used to determine a first resource block; and
transmitting a first signaling in the first resource block, the first signaling being used to indicate a first index;
wherein the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

16. A second node for wireless communications, comprising:
a second transmitter, transmitting a first information block, the first information block being used to determine a first resource block; and
a second receiver, receiving a first signaling in the first resource block, the first signaling being used to indicate a first index;
wherein the first index is one of multiple candidate indexes, and any of the multiple candidate indexes is a non-negative integer; any of the multiple candidate indexes corresponds to at least one reference signal resource, and an uplink transmission being associated with a reference signal resource corresponding to the first index is non-synchronised.

17. The second node according to claim 16, characterized in comprising:
the second transmitter, transmitting a first timing advance command;
wherein as a response to the first timing advance command being received by a transmitter of the first signaling, the transmitter of the first signaling canceled the first out-of-sync report; the first timing advance command is used to indicate an amount of timing advance being associated with the reference signal resource corresponding to the first index.

18. The second node according to claim 16, characterized in comprising:
the second transmitter, transmitting a first DCI, the first DCI being used to indicate a first reference signal resource, the first reference signal resource being used for a first random access procedure;
wherein the first reference signal resource is associated with the first index; the first DCI is a physical layer signaling.

19. The second node according to claim 16, characterized in comprising:
the second receiver, receiving a first signal, the first signal including a random access preamble; and
the second transmitter, transmitting a second DCI as a response to the first signal being received;
wherein the first signal is transmitted according to the first DCI; the first signal and the second DCI belong to the first random access procedure; the second DCI is a physical layer signaling.

20. The second node according to claim 16, characterized in that the first signaling comprises a UCI, a field of the UCI indicating the first index;
or,
the first signaling comprises a MAC CE, a field of the MAC CE indicating the first index.
